(19) United States
(12) Patent Application Publication
(10) Pub. No.: US 2006/0276283 A1
(43) Pub. Date: Dec. 7, 2006

(54) Mobile machine for screeding floor surfaces and the like

(76) Inventor: Hakan Thysell, Soderkoping (SE)

Correspondence Address: HARNESS, DICKEY & PIERCE, P.L.C., P.O. BOX 8910, RESTON, VA, 20195, US

(21) Appl. No.: 11/141,195

(22) Filed: Jun. 1, 2005

(51) Int. Cl. F16H 7/00

(52) U.S. Cl. 474/85; 474/87

(57) ABSTRACT

A mobile machine for screeding floor surfaces and the like comprises a planet disk, which is rotatably supported and driven by a drive motor, and which carries at least one screeding disk, operatively connected to the drive motor and defining one screeding plane. The operative connection comprises at least one belt or chain running over a belt sheave connected to the screeding disk, and a belt sheave connected to the drive motor. The belt sheave of the screeding disk has a central stub axle forming part of an automotive wheel hub, comprising wheel bolts attached to said planet disk.

### FIELD OF THE INVENTION

The present invention relates to a mobile machine for screeding floor surfaces and the like.

### BACKGROUND ART

A machine of that type is previously known from the applicant's PCT-application WO02/062524, which is hereby incorporated by reference.

A screeding machine of the aforementioned type uses several screeding disks which are mounted on specially designed holders comprising roller bearings. Due to heavy loads and vibrations while screeding and due to the dust produced thereby, the holders tend to deteriorate quite rapidly and thus have to be replaced rather frequently. For a user this causes costs both for repair works and for interrupted screeding as well as for spare parts, which are expensive primarily due to low production series.

### OBJECT OF THE INVENTION

It is obvious that the user situation described is not ideal and that there is need of an improvement.

Thus, the object of the present invention is to introduce a mobile machine for screeding floor surfaces and the like, comprising holders which are extremely robust and yet cheaper to replace than the known ones once they are worn out.

### SUMMARY OF THE INVENTION

According to the invention this is achieved by means of a mobile machine for screeding floor surfaces and the like, said machine comprising a planet disk, which is rotatably supported and driven by a drive motor, and which carries at least one screeding disk, operatively connected to the drive motor and defining one screeding plane, the operative connection comprising at least one belt or chain running over a belt sheave connected to the screeding disk, and a belt sheave connected to the drive motor, the belt sheave of the screeding disk having a central stub axle forming part of an automotive wheel hub, comprising wheel bolts attached to said planet disk.

Using automotive wheel hubs means use of a new type of holder produced in great numbers at a relatively low cost and made for withstanding great loads as well as tough environmental circumstances. This makes them particularly suited for screeding actions, where heavy loads, vibrations and dust are eminent, and solves all the problems with the prior art devices mentioned hereinbefore.

According to a currently preferred embodiment of invention the belt sheave of the screeding disk has a hub part, said stub axle extending through a central hole in said hub part and being secured to said hub part by a fastening device. This way rotational movement of the belt sheave is transferred to the stub axle in a secure way.

According to a currently preferred embodiment of invention, the belt sheave of the screeding disk has a hub part, said stub axle being furnished with a section of threads for fastening it to said hub part. An advantage of this embodiment is that the hub part may be screwed onto the stub axle and/or a fastening device may be screwed onto the stub axle, which is an efficient way of fastening and allows for simple assembling.

According to a currently preferred embodiment of invention the belt sheave of the screeding disk has a hub part, said hub part abutting a rotatable runner of the wheel hub on a side opposite to the side of the wheel hub facing the planet disk, said stub axle being a bolt extending through a central hole in said hub part and through said runner and fixing the belt sheave onto said runner by means of a nut. The advantage of this embodiment is that it is easy to assemble and that the bolt shaped stub axle is reuseable because it is not an integral part of the wheel hub.

Furthermore, the belt sheave of the screeding disk preferably are cup shaped protectively surrounding the wheel hubs. The advantage of this embodiment is that it provides extra protection for the wheel hubs against dust and that it reduces the height of the belt sheave/wheel hub combination to a minimum.

The belt or chain may also run over least one deflection sheave. This facilitates providing the correct tension of the belt or chain since the deflection sheave can be made adjustable.

The mobile machine may comprises a number of screeding disks, each being operatively connected to the drive motor. Hence, mobile machines having large capacity may be provided.

### BRIEF DESCRIPTION OF THE DRAWINGS

A preferred embodiment of the invention will be explained in more detail below with reference to the drawings attached, in which

FIG. 1, in an oblique, perspective view from beneath, shows a screeding unit of a known screeding machine, having a drive motor and a dished planet disk, which accommodates a belt transmission,

FIG. 1b shows the drive motor and the planet disk in FIG. 1a in an oblique perspective view from above,

FIG. 1c shows essentially the same view as FIG. 1a, but the planet disk and the belt transmission are covered by a cover plate with openings for the machine's screeding disks, and

FIG. 2, in a vertical sectional view, shows a wheel hub forming part of the preferred embodiment of a screeding machine according to the invention.

### DESCRIPTION OF THE PREFERRED EMBODIMENT

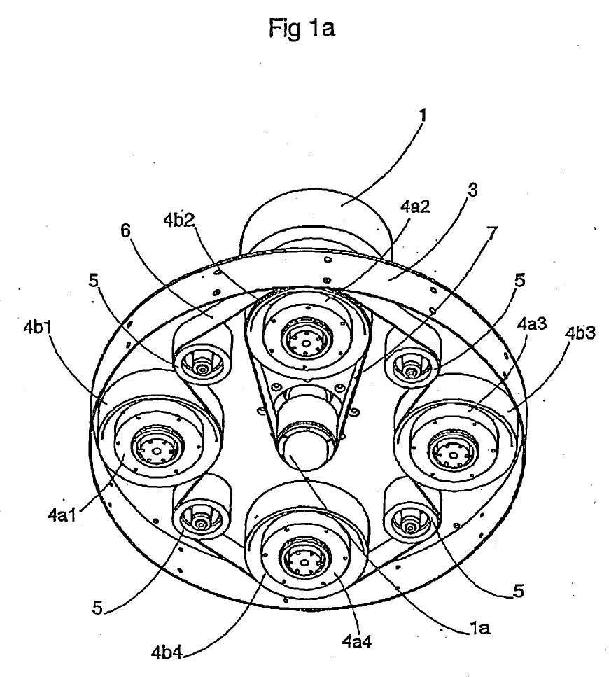

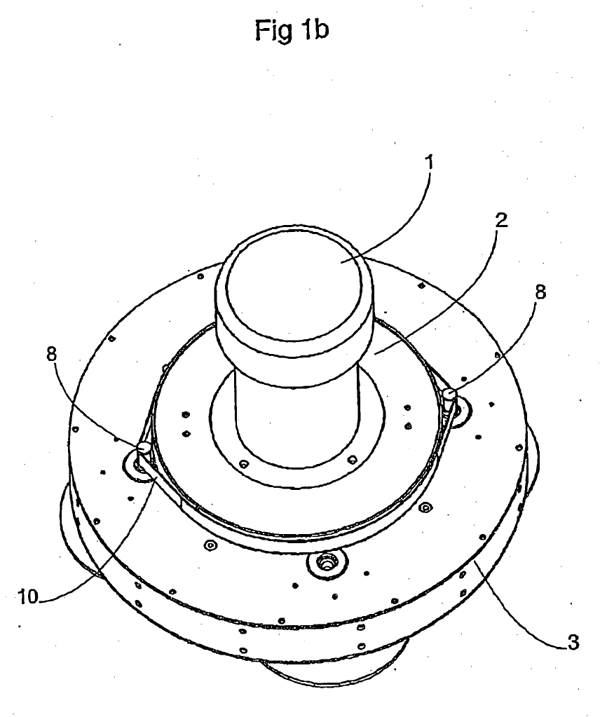

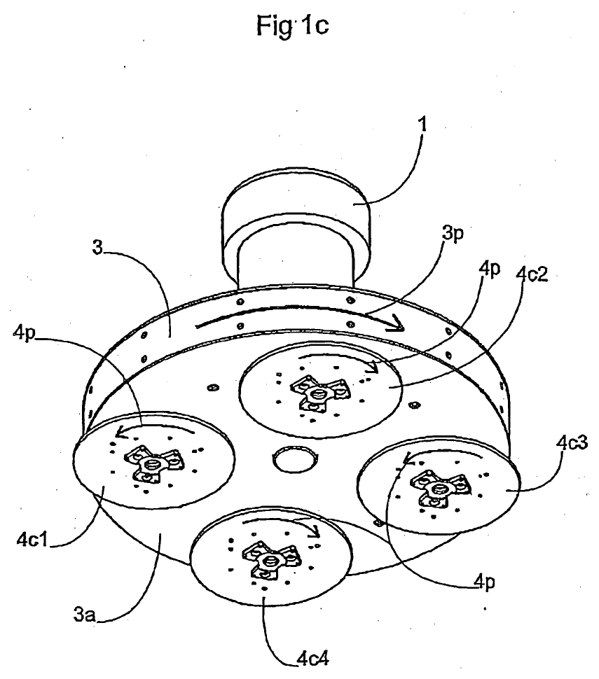

In FIGS. 1a, 1b and 1c numeral 1 denotes a drive motor mounted on a motor plate 2 of a screeding machine casing, not shown further, by means of a screw nut connection.

Inside the screeding machine casing there is a planet disk 3, which is supported so that it can rotate in relation to the motor plate of said housing. The planet disk 3 is shaped like a dish open at the bottom. When the screeding unit is ready for use the dish is covered by a protective plate 3a having openings for screeding disks 4c1-4c4. The dish with the protective plate 3a forms a protected space for the drive mechanism. The space accommodates four symmetrically located holders 4a1-4a4 for said screeding disks 4c1-4c4, the holders being supported so that they can rotate, in the planet disk 3. For the sake of clarity, the screeding disks have been omitted from FIG. 1a but are shown in FIG. 1c, in which the directions of rotation, according to the shown embodiment, of the screeding disks 4c1-4c4 and the planet disk 3 are also illustrated by arrows 3p and 4p respectively. A belt sheave 4b1-4b4 is connected to each holder 4a1-4a4 for driving each screeding disk in a known manner. A belt 6 runs over the belt sheaves 4b1-4b4 and over deflection sheaves 5 arranged between them. A belt sheave 1a arranged on the shaft of the motor 1 is designed to drive the belt sheave 4b2 by way of a belt 7, thereby causing the other belt sheaves to rotate. Since the belt 6 runs over that section of the circumference situated nearest to the centre of the planet disk 3 in respect of the belt sheaves 4b1 and 4b3 and over the section of the circumference situated furthest away from the said centre in respect of the belt sheaves 4b2 and 4b4, the belt sheaves 4b1, 4b3 assume opposing directions of rotation relative to the belt sheaves 4b2, 4b4, thereby providing the characteristic feature of the adjacent screeding disks having opposite directions of rotation.

From FIG. 1b it can be seen that shafts of the belt sheaves 4b1, 4b3 protrude from the dished planet disk 3 and form belt sheaves 8. A belt sheave 9 is fixed to the motor plate 2. A belt 10, by means of which the rotation of the motor 1 is transmitted to the planet disk 3 by way of the belt sheave 1a, the belt 7, the belt sheave 4a2, the belt 6 and the belt sheaves 4b1, 4b3, runs over the belt sheaves 8 and 9. It may be noted in this connection that the planet sheave 3 has the same direction of rotation as the screeding disks 4c2, 4c4.

The screeding device described above, known from the applicant's PCT-application WO02/062524, comprises what is called holders 4c1-4c4. These were developed especially for screeding machines and, as the market is rather small, they are not produced in very large numbers, which of course makes them quite expensive.

In order to lower the costs for all parties involved, the applicant began looking for alternative holders and finally found that automotive wheel hubs were the ideal solution. They turned out to be extremely durable and relatively cheap too.

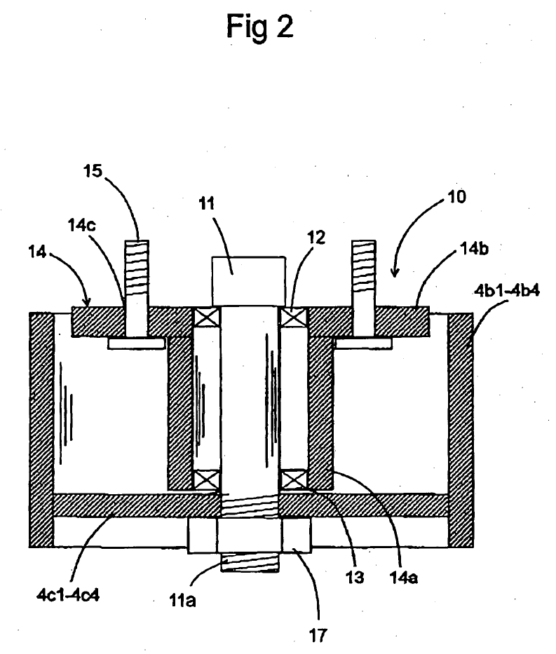

In FIG. 2 one such automotive wheel hub 10 is shown in a schematic sectional view. It comprises a central shaft 11, which is surrounded by two roller bearings 12, 13. These are mounted in a hollow central sleeve 14a a of a rim part 14, said rim part 14 further having a disk shaped flange 14b surrounding said sleeve 14a. The flange 14b has holes 14c for wheel bolts 15, which are closely fitting mounted within said holes 14c protruding on one of the flat sides of the flange 14b.

The skilled person realises that the schematically shown wheel hub 10 described this far is just like any ordinary or standard wheel hub on the market and that there are a few parts not shown, like sealings, which are not relevant for this disclosure.

A first difference to known automotive wheel hubs is that it is the central shaft 11 of the wheel hub 10 that forms the runner, i.e. the rotatable part, of the wheel hub 10. This is due to the wheel hub 10 being mounted on a planet disk 3 of a screeding machine by means of said wheel bolts 15 and the flange 14b therefore not being rotatable, but it does not affect the structure of a standard wheel hub as such.

A second difference is that the central shaft 11 is a stub axle having a section 11a furnished with threads. This is due to use thereof for mounting a screeding disk 4c1-4c4 of the kind described hereinbefore by screwing it on said shaft 11. In an alternative embodiment the shaft 11 is a bolt. Part of the shaft extends through said screeding disk 4c1-4c4 and a fastening device 17 is used to secure the screeding disk 4c1-4c4 to the shaft 11. In FIG. 2 there is shown a fastening device in the form of a nut 17 which is screwed onto the shaft 11. Other ways of fastening may for example include use of a cotter pin, or any other suitable type of fastening device known to the person skilled in the art. In an alternative embodiment, the shaft 11 is not a solid stub axle but a hollow sleeve. This is due to use thereof for mounting a screeding disk 4c1-4c4 of the kind described hereinbefore by means of a bolt 11 extending through said sleeve and a nut 17 screwed onto the bolt 11. Thus, the screeding disk 4c1-4c4 becomes rotatable vis-à-vis the planet disk 3 of the screeding machine. Even said second difference does not affect the structure of said standard wheel hub.

A third difference is that the wheel hub 10 is circumferentially surrounded not by a wheel but by a belt sheave 4b1-4b4 of a screeding machine. By surrounding the wheel hub 10 the belt sheave 4b1-4b4 effectively protects the roller bearings 12, 13 against dust produced while screeding, thereby prolonging life of the wheel hub 10. Neither the third difference affects the structure of said standard wheel hub. Thus, it is obvious that almost any standard automotive wheel hub is usable for the screeding machine according to the preferred embodiment of the invention.

Although the invention above has been primarily illustrated and explained in connection with a screeding unit for a manually operated screeding machine, it is be obvious that the screeding machine according to the invention affords the same advantages when it is fitted to a powered screeding machine.

It is recognized that the belt may be any known belt, such as a frictionally engaging belt or a toothed belt, and the chain may be any suitable transmission chain.

It is further recognized that although the screeding machine is shown as having four screeding disks, the invention is applicable to any screeding machine having at least one screeding disk.

1. A mobile machine for screeding floor surfaces and the like, said machine comprising a planet disk, which is rotatably supported and driven by a drive motor, and which carries at least one screeding disk, operatively connected to the drive motor and defining one screeding plane, the operative connection comprising at least one belt or chain running over a belt sheave connected to the screeding disk, and a belt sheave connected to the drive motor, the belt sheave of the screeding disk having a central stub axle forming part of an automotive wheel hub, comprising wheel bolts attached to said planet disk.

2. A mobile machine according to claim 1, the belt sheave of the screeding disk having a hub part, said stub axle extending through a central hole in said hub part and being secured to said hub part by a fastening device.

3. A mobile machine according to claim 1, the belt sheave of the screeding disk having a hub part, said stub axle being furnished with a section of threads for fastening it to said hub part.

4. A mobile machine according to claim 1, the belt sheave of the screeding disk having a hub part, said hub part abutting a rotatable runner of the wheel hub on a side opposite to the side of the wheel hub facing the planet disk, said stub axle being a bolt extending through a central hole in said hub part and through said runner and fixing the belt sheave onto said runner by means of a nut.

5. A mobile machine according to claim 1, the belt sheave of the screeding disk being-cup shaped protectively surrounding the wheel hubs.

6. A mobile machine according to claim 1, wherein the belt or chain runs over least one deflection sheave.

7. A mobile machine according to claim 1, wherein the mobile machine comprises a number of screeding disks, each being operatively connected to the drive motor.
